(19) United States
(12) Patent Application Publication
(10) Pub. No.: US 2021/0198160 A1
(43) Pub. Date: Jul. 1, 2021

(54) DENSE MULTI-PHASE BOND COAT

(71) Applicants: Rolls-Royce High Temperature Composites, Inc., Cypress, CA (US); Rolls-Royce Corporation, Indianapolis, IN (US)

(72) Inventors: Sungbo Shim, Irvine, CA (US); Ann Bolcavage, Indianapolis, IN (US); Robert J. Shinavski, Mission Viejo, CA (US)

(21) Appl. No.: 16/721,541

(22) Filed: Dec. 19, 2019

Related U.S. Application Data
(60) Provisional application No. 62/782,833, filed on Dec. 20, 2018.

(51) Int. Cl. C04B 41/52; C04B 35/80; C04B 41/00; C04B 41/45; C04B 41/50; C04B 41/89; C04B 41/87

(52) U.S. Cl. CPC C04B 41/522; C04B 35/80; C04B 41/009; C04B 41/4552; C04B 41/87; C04B 41/5066; C04B 41/5059; C04B 41/89; C04B 41/4539

(57) ABSTRACT

A method includes depositing a porous silicon coat on a substrate to form a bulk phase of a bond coat and introducing a reactive gas into pores of the porous silicon coat. The reactive gas reacts with silicon adjacent the pores of the porous silicon coat to form a ceramic phase of the bond coat comprising a silicon-based ceramic and reduce porosity of the porous silicon coat. A temperature of the reactive gas is greater than about 1000° C.

This application claims the benefit of U.S. Provisional Application No. 62/782,833, filed Dec. 20, 2018, which is incorporated herein by reference in its entirety

### TECHNICAL FIELD

The present disclosure generally relates to techniques for increasing the density of a bond coat.

### BACKGROUND

Ceramic or ceramic matrix composite (CMC) substrates may be useful in a variety of contexts where mechanical and thermal properties are important, such as, for example, gas turbine engines. Some ceramic or CMC substrates may react with some elements and compounds present in the operating environment of high temperature mechanical systems, such as, for example, oxygen or water vapor. Reaction with oxygen or water vapor may damage the ceramic or CMC substrate and reduce mechanical properties of the ceramic or CMC substrate, which may reduce the useful lifetime of the component. Thus, a ceramic or CMC substrate may be coated with an environmental barrier coating (EBC) to reduce exposure of the ceramic or CMC substrate to elements and compounds present in the operating environment of high temperature mechanical systems. In some examples, a bond coat may be present between the EBC and the substrate to improve adhesion of the EBC to the substrate.

### SUMMARY

In general, the disclosure is directed to a dense multi-phase silicon bond coat.

In some examples, a method includes depositing a porous silicon coat on a substrate to form a bulk phase of a bond coat and introducing a reactive gas into pores of the porous silicon coat. The reactive gas reacts with silicon adjacent the pores of the porous silicon coat to form a ceramic phase of the bond coat that includes a silicon-based ceramic and reduce porosity of the porous silicon coat. A temperature of the reactive gas is greater than about 1000° C.

In some examples, an article includes a substrate, a bond coat on the substrate, and a barrier coating on the bond coat. The bond coat includes a bulk phase of silicon and a ceramic phase of a silicon-based ceramic. The bond coat includes greater than about 0.5 vol. % and less than about 15 vol. % of the ceramic phase.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a cross-sectional diagram of an example of an article that includes a substrate coated with a bond coat and a barrier coating.

FIG. 2A is a cross-sectional diagram of an example of an article that includes a substrate coated with a bond coat prior to introduction of a reactive gas.

FIG. 2B is a cross-sectional diagram of an example of an article that includes a substrate coated with a bond coat after introduction of a reactive gas.

FIG. 3 is a flowchart of an example process for manufacturing an article that includes a substrate coated with a bond coat and a barrier coating.

### DETAILED DESCRIPTION

In general, the disclosure describes example techniques for increasing the density of a silicon bond coat. Such techniques may be used, for example, to increase the density of a bond coat on a substrate, such as a ceramic or ceramic matrix composite (CMC) material. The techniques may include depositing a porous silicon coat on a substrate to form a bulk phase of a bond coat and introducing a hot reactive gas into pores of the porous silicon coat. The hot reactive gas reacts with silicon adjacent the pores to form a ceramic phase of the bond coat. The volume of the resulting silicon-based ceramic of the ceramic phase is greater than the volume of the silicon adjacent the pores, such that the ceramic phase closes off pores of the bond coat and reduces an open porosity of the bond coat. For example, the bond coat may include greater than about 0.5 vol. % and less than about 15 vol. % of the ceramic phase, corresponding to volumes in the bond coat previously occupied by pores and silicon adjacent the pores.

In some examples, ceramic or CMC substrates may include silicon metal or a silicon-containing alloy or ceramic, such as silicon carbide or silicon nitride. Materials including silicon metal or a silicon-containing alloy or ceramic may be vulnerable to chemical attack by elements and compounds (e.g., oxygen or water vapor) present in the operating environment of high temperature mechanical systems or during servicing of high temperature mechanical system. For example, oxygen or water vapor may chemically attack a ceramic or CMC substrate that includes silicon to form silicon dioxide or silicon hydroxide species and damage the ceramic or CMC substrate. The ceramic or CMC substrate may be coated with an environmental barrier coating (EBC), which may reduce elements or compounds from the operating environment from contacting the ceramic or CMC substrate and reacting with the ceramic or CMC substrate. However, these elements or compounds may still penetrate through the EBC and contact the ceramic or CMC substrate.

In some examples, a bond coat is between the ceramic or CMC substrate and the EBC and may enhance adherence of the EBC to the ceramic or CMC substrate. The bond coat may be deposited on a ceramic or CMC substrate by a coating process that forms a porous network within the bond coat, such as thermal spraying. The porosity network within the bond coat may allow infiltration of elements or compounds from the operating environment (e.g., oxygen or water vapor) through the bond coat, potentially resulting in contact of the elements or compounds with the substrate. This may result in oxidation of the ceramic or CMC substrate and may lead to premature failure of the ceramic or CMC substrate/EBC system.

The disclosure describes techniques to increase the density of the bond coat to reduce the open porosity of the bond coat and thereby reduce the permeability of the bond coat to elements and compounds that may otherwise damage the underlying substrate. For example, a technique for increasing the density of a bond coat may include depositing a porous silicon coat on a substrate and introducing a hot reactive gas into pores of the porous silicon coat to react with silicon adjacent the pores to form a ceramic phase of the bond coat. The volume of the resulting silicon-based ceramic of the ceramic phase is greater than the volume of the silicon adjacent the pores, such that the ceramic phase closes off or reduces a size of pores of the bond coat, thereby reducing an open porosity of the bond coat. By reducing open porosity of the bond coat and substantially eliminating continuous porosity extending through a thickness of the bond coat, diffusion of environmental species, such as oxygen or water vapor, through the bond coat to the substrate may be reduced or substantially eliminated, reducing or substantially eliminating chemical attack of the substrate by environmental species.

In addition to reducing an open porosity of the bond coat, increasing the density of the bond coat may improve other properties of the bond coat. For example, a ceramic phase distributed throughout the bond coat in volumes previously occupied by pores may increase creep resistance of the bond coat, such that the bond coat may be more dimensionally stable at high temperatures. As another example, the ceramic phase of the bond coat may increase the stiffness of the bond coat, such that the bond coat may be more resistant to fracture.

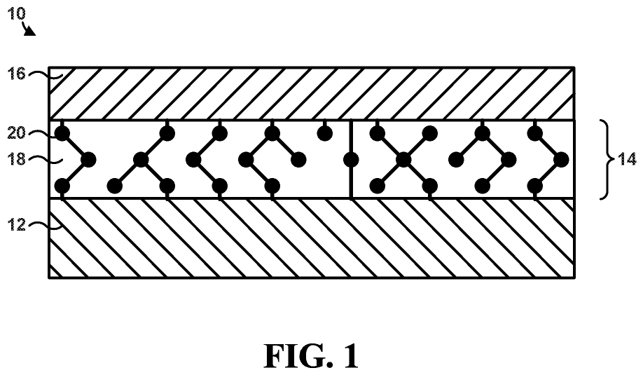

FIG. 1 is a conceptual and schematic diagram illustrating a cross-sectional view of an example of an article 10 used in a high-temperature mechanical system. The article 10 includes a bond coat 14 on a substrate 12 and a barrier coating 16 on bond coat 14.

Substrate 12 is a component of a high temperature mechanical system, such as, for example, a gas turbine engine or the like. Substrate 12 may include a ceramic or ceramic matrix composite (CMC). In some examples in which substrate 12 includes a ceramic, the ceramic may be substantially homogeneous. In some examples, a substrate 12 that includes a ceramic includes, for example, a silicon-containing ceramic, such as silica (SiO₂), silicon carbide (SiC) or silicon nitride (Si₃N₄); alumina (Al₂O₃); aluminosilicate; or the like. In other examples, substrate 12 includes a metal alloy that includes silicon, such as a molybdenum-silicon alloy (e.g., MoSi₂) or a niobium-silicon alloy (e.g., NbSi₂).

In examples in which substrate 12 includes a CMC, substrate 12 includes a matrix material and a reinforcement material. The matrix material includes a ceramic material, such as, for example, silicon carbide, silicon nitride, alumina, aluminosilicate, silica, or the like. The CMC further includes a continuous or discontinuous reinforcement material. For example, the reinforcement material may include discontinuous whiskers, platelets, or particulates. As other examples, the reinforcement material may include a continuous monofilament or multifilament weave.

In some examples, the composition of the reinforcement material is the same as the composition of the matrix material. For example, a matrix material comprising silicon carbide may surround a reinforcement material comprising silicon carbide whiskers. In other examples, the reinforcement material includes a different composition than the composition of the matrix material, such as aluminosilicate fibers in an alumina matrix, or the like. One composition of a substrate 12 that comprises a CMC includes a reinforcement material comprising silicon carbide continuous fibers embedded in a matrix material comprising silicon carbide. In some examples, substrate 12 may have an additional matrix layer on a surface of substrate 12. This additional matrix layer may protect reinforcement material, which may be more susceptible to reaction with elements than the matrix layer.

As shown in FIG. 1, article 10 includes barrier coating 16 on bond coat 14. Barrier coating 16 may include, for example, an environmental barrier coating (EBC), an abradable layer, a thermal barrier coating (TBC), a calcia-magnesia-aluminosilicate (CMAS)-resistant layer, or the like. In some examples, a single barrier coating 16 may perform two or more of these functions. For example, an EBC may provide environmental protection, thermal protection, CMAS-resistance, and the like to substrate 12. As another example, an abradable layer may provide wear protection, impact protection, and the like to substrate 12. In some examples, instead of including a single barrier coating 16, article 10 may include a plurality of barrier coatings or other overlying layers, such as at least one EBC layer, at least one abradable layer, at least one TBC layer, at least one CMAS-resistant layer, or combinations thereof. Barrier coating 16 may be formed on a surface of bond coat 14 using, for example, thermal spraying, including, air plasma spraying, high velocity oxy-fuel (HVOF) spraying, low vapor plasma spraying; PVD, including EB-PVD, DVD, and cathodic arc deposition; CVD; slurry process deposition; sol-gel process deposition; electrophoretic deposition; or the like. As will be explained further below, in some examples, barrier coating 16 may be porous, such that barrier coating 16 may permit reactive gas to flow through barrier coating 16 to bond coat 14.

An EBC layer may include at least one of a rare earth oxide, a rare earth silicate, an aluminosilicate, or an alkaline earth aluminosilicate. For example, an EBC layer may include mullite, barium strontium aluminosilicate (BSAS), barium aluminosilicate (BAS), strontium aluminosilicate (SAS), at least one rare earth oxide, at least one rare earth monosilicate (RE₂SiO₅, where RE is a rare earth element), at least one rare earth disilicate (RE₂Si₂O₇, where RE is a rare earth element), or combinations thereof. The rare earth element in the at least one rare earth oxide, the at least one rare earth monosilicate, or the at least one rare earth disilicate may include at least one of Lu (lutetium), Yb (ytterbium), Tm (thulium), Er (erbium), Ho (holmium), Dy (dysprosium), Tb (terbium), Gd (gadolinium), Eu (europium), Sm (samarium), Pm (promethium), Nd (neodymium), Pr (praseodymium), Ce (cerium), La (lanthanum), Y (yttrium), or Sc (scandium).

In some examples, an EBC layer may include at least one rare earth oxide and alumina, at least one rare earth oxide and silica, or at least one rare earth oxide, silica, and alumina. In some examples, an EBC layer may include an additive in addition to the primary constituents of the EBC layer. For example, an EBC layer may include at least one of TiO₂, Ta₂O₅, HfSiO₄, an alkali metal oxide, or an alkali earth metal oxide. The additive may be added to the EBC layer to modify one or more desired properties of the EBC layer. For example, the additive components may increase or decrease the reaction rate of the EBC layer with CMAS, may modify the viscosity of the reaction product from the reaction of CMAS and the EBC layer, may increase adhesion of the EBC layer to bond coat 14, may increase or decrease the chemical stability of the EBC layer, or the like.

In some examples, the EBC layer may be substantially free (e.g., free or nearly free) of hafnia and/or zirconia. Zirconia and hafnia may be susceptible to chemical attack by CMAS, so an EBC layer substantially free of hafnia and/or zirconia may be more resistant to CMAS attack than an EBC layer that includes zirconia and/or hafnia.

Regardless of the composition of the EBC layer, in some examples, the EBC layer may have a dense microstructure, a porous microstructure, a columnar microstructure, or a combination of at least two of dense, porous, or columnar microstructures. A dense microstructure may be more effective in preventing the infiltration of CMAS and other environmental contaminants, while a porous or columnar microstructure may be more strain tolerant during thermal cycling. A combination of dense, porous, and columnar microstructures may be more effective in preventing the infiltration of CMAS or other environmental contaminants than a porous or fully columnar microstructure while being more strain tolerant during thermal cycling than a fully dense microstructure. In some examples, an EBC layer with a dense microstructure may have a porosity of less than about 10 vol. %, such as less than about 8 vol. %, less than about 5 vol. %, or less than about 2 vol. %, where porosity is measured as a percentage of pore volume divided by total volume of the EBC layer. In some examples, an EBC layer with a porous microstructure may have a porosity of more than about 10 vol. %, such as more than about 15 vol. %, more than 20 vol. %, or more than about 30 vol. %, where porosity is measured as a percentage of pore volume divided by total volume of the EBC layer.

As described above, the EBC layer may be used as a single barrier coating 16 or may be used in combination with at least one other layer, such as an abradable layer or TBC layer.

Barrier coating 16 additionally or alternatively may include an abradable layer. Abradability may include a disposition to break into relatively small pieces when exposed to a sufficient physical force. Abradability may be influenced by the material characteristics of the abradable layer, such as fracture toughness and fracture mechanism (e.g., brittle fracture), as well as the porosity of the abradable layer. Thermal shock resistance and high temperature capability may be important for use in a gas turbine engine, in which the abradable layer is exposed to wide temperature variations from high operating temperatures to low environmental temperatures when the gas turbine engine is not operating. In addition to at least some of the above properties, the abradable layer may possess other properties.

The abradable layer may include any suitable material. For example, the abradable layer may include at least one of a rare earth oxide, a rare earth silicate, an aluminosilicate, or an alkaline earth aluminosilicate. For example, an abradable layer may include mullite, BSAS, BAS, SAS, at least one rare earth oxide, at least one rare earth monosilicate, at least one rare earth disilicate, or combinations thereof. In some examples, the abradable layer may include any of the compositions described herein with respect to the EBC layer.

The abradable layer may be porous. Porosity of the abradable layer may reduce a thermal conductivity of the abradable layer and/or may affect the abradability of the abradable layer. In some examples, the abradable layer includes porosity between about 10 vol. % and about 50 vol. %. In other examples, the abradable layer includes porosity between about 15 vol. % and about 35 vol. %, or about 20 vol. %. Porosity of the abradable layer is defined herein as a volume of pores or cracks in the abradable layer divided by a total volume of the abradable layer (including both the volume of material in the abradable layer and the volume of pores/cracks in the abradable layer).

The abradable layer may be formed using, for example, a thermal spraying technique, such as, for example, plasma spraying. Porosity of the abradable layer may be controlled by the use of coating material additives and/or processing techniques to create the desired porosity. In some examples, substantially closed pores may be desired.

As described above, the abradable layer may be used as a single barrier coating 16 or may be used in combination with at least one other layer, such as an EBC layer or TBC layer.

Barrier coating 16 additionally or alternatively may include a TBC layer. The TBC layer may have a low thermal conductivity (i.e., both an intrinsic thermal conductivity of the material(s) that forms the TBC layer and an effective thermal conductivity of the TBC layer as constructed) to provide thermal insulation to substrate 12, bond coat 14, and/or barrier coating 16. Heat is transferred through the TBC layer through conduction and radiation. The inclusion of rare earth oxides such as ytterbia, samaria, lutetia, scandia, ceria, gadolinia, neodymia, europia, yttria-stabilized zirconia (YSZ), zirconia stabilized by a single or multiple rare earth oxides, hafnia stabilized by a single or multiple rare earth oxides, zirconia-rare earth oxide compounds, such as RE₂Zr₂O₇ (where RE is a rare earth element), hafnia-rare earth oxide compounds, such as RE₂Hf₂O₇ (where RE is a rare earth element), and the like as dopants may help decrease the thermal conductivity (by conduction) of the TBC layer.

As described above, the TBC layer may be used as a single barrier coating 16 or may be used in combination with at least one other layer, such as an EBC layer or an abradable layer.

As shown in FIG. 1, article 10 includes a bond coat 14 on substrate 12, between substrate 12 and barrier coating 16. Bond coat 14 may improve adhesion between substrate 12 and the layer overlying bond coat 14 (e.g., barrier coating 16 in FIG. 1). In some examples, bond coat 14 may be directly on a surface of substrate 12 with no intermediate layers between substrate 12 and bond coat 14. In other examples, bond coat 14 may not be disposed directly on a surface of substrate 12, i.e., one or more additional intermediate layers may be between substrate 12 and bond coat 14. For example, an additional intermediate bond coat layer may be between substrate 12 and bond coat 14. In some examples, bond coat 14 may be on all of the surface of substrate 12. In other examples, bond coat 14 may be on only a part of the surface of substrate 12. For example, bond coat 14 may be on a portion of substrate 12 that is exposed to a flow path of hot gases in a gas turbine engine. In other examples, bond coat 14 may be on non-gas flow path areas, such as a backside of a seal segment or a blade dovetail region. Bond coat 14 may be formed on substrate 12 using, for example, thermal spraying, e.g., air plasma spraying, high velocity oxy-fuel (HVOF) spraying, low vapor plasma spraying; physical vapor deposition (PVD), e.g., electron beam physical vapor deposition (EB-PVD), directed vapor deposition (DVD), cathodic arc deposition; chemical vapor deposition (CVD); slurry process deposition; sol-gel process deposition; electrophoretic deposition; or the like.

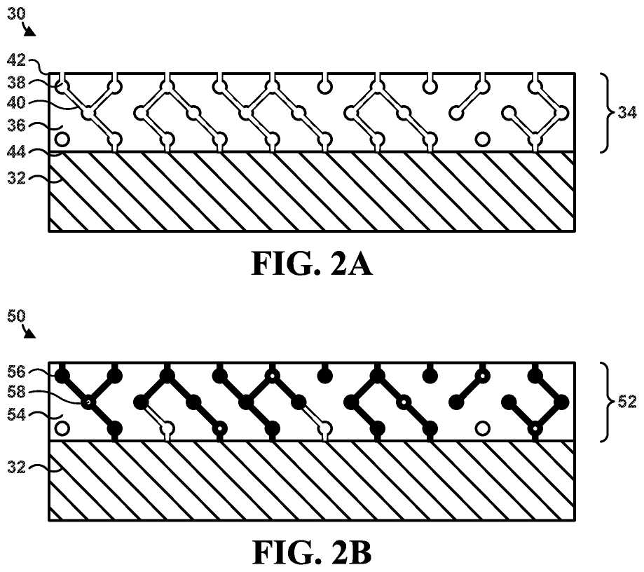

Bond coat 14 may include a bulk phase 18 and a ceramic phase 20 dispersed in bulk phase 18. As will be explained further in FIGS. 2A and 2B, ceramic phase 20 may be dispersed such that ceramic phase 20 displaces at least a portion of a volume previously occupied by pores, such that bond coat 14 is denser than a bond coat without the ceramic phase. Bulk phase 18 may include silicon such as silicon metal (e.g., elemental silicon), a silicon-containing alloy, or a silicon-containing compound. In some examples, the presence of silicon in bond coat 14 may promote adherence between bond coat 14 and substrate 12, such as, for example, when substrate 12 includes silicon metal or a silicon-containing alloy or compound. Silicon-containing alloys that may be used include, but are not limited to, YbSi, YbGdSi, YbGdYSi, ZrSi+Y, ZrSi+Ta, GdYbSi+Hf, and the like.

Ceramic phase 20 includes a silicon-based ceramic. The silicon-based ceramic may include any silicon-based ceramic that may be formed from a reaction between a reactive gas, as explained in FIGS. 2A and 2B below, and a silicon constituent of bond coat 14, such as silicon metal or silicon in a silicon alloy. Silicon-based ceramics may include, but are not limited to: non-oxide silicon ceramics, such as silicon nitride (Si₃N₄), silicon carbide (SiC), silicon carbide nitride, and silicides, such as calcium silicide, magnesium silicide, and molybdenum disilicide; silicon oxynitride (SiOₓN_{y}); silicas (SiO₂); silicates, such as mullite; silicon-aluminum-oxygen-nitrogen (SiAlON); and the like.

The silicon-based ceramic shall have a molar volume per mol of silicon that is greater than a molar volume of silicon. A molar volume (Vₘ) may be a volume occupied by one mole of a substance, and may be related to a molar mass (M) at a density (ρ), as represented by the following equation:

Vₘ=M/ρ

For example, a mole of silicon (Si) may have a molar volume of about 12.1 cm³/mol Si. In contrast, a silicon-based ceramic such as silicon nitride may have a molar volume of about 44.2 cm³/mol Si₃N₄, or about 14.7 cm³/mol Si (as Si₃N₄ has 3 silicon atoms). As such, a molar volume per mole of silicon for silicon nitride is greater than a molar volume of silicon or, put another way, a volume occupied by a mole of silicon nitride is greater than a volume occupied by three moles of silicon. As such, a silicon-based ceramic formed from silicon in bond coat 14, such as silicon nitride from silicon, may occupy a greater volume than the silicon from which it formed. Properties of bulk phase 18 and ceramic phase 20 of bond coat 14 will be described further in FIG. 2B below.

In some examples, bond coat 14 includes greater than about 0.5 vol. % of ceramic phase 20. As will be explained below, a percentage of ceramic phase 20 in bond coat 14 may correspond to a continuous porosity of a porous silicon coat precursor of bond coat 14, such that bond coat 14 may include ceramic phase in an amount and distribution sufficient to close or reduce substantially all continuous porosity in bond coat 14. As such, not all pores in the porous silicon coat precursor may be replaced with ceramic phase 20, as a pore may be closed at one or points within a pore, while other volumes of the pore upstream or downstream of the closure may continue to have a void volume. As such, in some examples, bond coat 14 includes non-continuous pores adjacent ceramic phase 20 (e.g., closed porosity). However, a sufficient amount of porosity may be replaced by ceramic phase 20 to reduce a continuous porosity. In some examples, bond coat 14 includes less than about 15 vol. % of ceramic phase 20. For example, while ceramic phase 20 may close a continuous porosity of bond coat 14, it may result in more adverse effects upon oxidation such as greater loss of volume per mole of silicon oxidized, and additional gas product generation than silicon in bond coat 14, such that an amount of ceramic phase 20 may be balanced with closure or reduction of continuous porosity within bond coat 14. Additionally or alternatively, ceramic phase 20 may be limited by an amount of porosity within bond coat 14, as discussed above. In some examples, bond coat 14 includes greater than about 0.5 vol. % and less than about 15 vol. % of ceramic phase 20, such as less than 1 vol. % and less than about 10 vol. % of ceramic phase 20. The volume percentage of the ceramic phase in bond coat 14 may be determined using a variety of analytic methods including, for example, microscopy and image analysis.

In some examples, ceramic phase 20 may have an average module size that includes at least one micron-level dimension (e.g., width, radius, etc.). For example, as mentioned above, ceramic phase 20 may correspond to pores within the porous silicon coat precursor of bond coat 14. These pores may represent splat boundaries, granular pores, or other pores formed during formation of the silicon coat precursor. As such, dispersed modules of ceramic phase 20 have widths that correspond to narrow (i.e., micron-level) pores in bond coat 14.

In some examples, bond coat 14 may have a substantially even concentration of ceramic phase 20, and thus silicon-based ceramic, at a particular depth from barrier coating 16 (i.e. across an x-y plane of bond coat 14 parallel to a surface of substrate 12). For example, a concentration of silicon-based ceramic at a first sample location may be substantially equal to a concentration of silicon-based ceramic at a second sample location at a same depth. For example, as will be explained below, ceramic phase 20 may correspond roughly with a porosity of a porous silicon coat precursor coating, such that a substantially even distribution of pores within the silicon coat precursor coating may result in a substantially even distribution of silicon-based ceramic in bond coat 14.

In some examples, bond coat 14 may have a higher concentration of ceramic phase 20, and thus the silicon-based ceramic, adjacent to barrier coating 16 than adjacent to substrate 12 (i.e., along a z-direction normal from a surface of substrate 12). For example, as will be described in FIGS. 2A and 2B below, as a reactive gas reacts with silicon adjacent to pores in the aforementioned porous silicon coat precursor coating, a portion of the pores may close off, such that the reactive gas may not further infiltrate into the pores in the direction of substrate 12 and form the silicon-based ceramic. As such, more silicon-based ceramic may be formed near an outer surface than an inner surface of bond coat 14, resulting in a higher concentration near a surface of bond coat 14.

In some examples, the silicon-based ceramic of ceramic phase 20 may be selected for improved mechanical properties of bond layer 14. In some examples, ceramic phase 20 may increase creep resistance of bond coat 14, such that the bond coat may be more dimensionally stable at high temperatures. For example, the silicon-based ceramic may have creep-resistant properties and/or may increase a density of bond coat 14 by reducing porosity. In some examples, ceramic phase 20 of bond coat 14 may increase the toughness of bond coat 14, such that the bond coat 14 may be more resistant to fracture.

Bond coat 14 may include a composition that may be stable at temperatures above 1350° C. and/or above about 1410° C. For example, as will be explained below, significant volume fractions of silicon may be converted to the silicon-based ceramic (e.g., up to about 15%), such that the resulting bond coat 14 may be stable at temperatures above a melting point of silicon. In this way, bond coat 14 may allow use of article 10 at temperatures which lead to temperatures of bond coat 14 above 1350° C. and/or above about 1410° C. In some examples, article 10 may be used in an environment in which ambient temperature is greater than the temperature at which bond coat 14 is thermally stable, e.g., because bond coat 14 may be coated with at least one layer, such as barrier layer 16, that provides thermal insulation to bond coat 14 and reduces the temperature experienced by bond coat 14 compared to the ambient temperature or the surface temperature of the layer(s) formed on bond coat 14, e.g., barrier layer 16.

Bond coat 14 may optionally include at least one additive. The optional at least one additive may include, for example, at least one of an oxidation enhancer, a transition metal carbide, a transition metal boride, a transition metal nitride, or a rare earth silicate forming a second ceramic phase.

In examples in which bond coat 14 includes an oxidation enhancer, the oxidation enhancer may include at least one of molybdenum, hafnium, or ytterbium. In some examples in which bond coat 14 includes an oxidation enhancer, bond coat 14 may include greater than 0 wt. % and less than about 10 wt. % of the oxidation enhancer. In some examples, bond coat 14 may include at least two oxidation enhancers, and bond coat 14 may include greater than 0 wt. % and less than about 10 wt. % of each of the at least two oxidation enhancers. The oxidation enhancer may facilitate formation of a stable oxide scale on a surface of bond coat 14, which may increase adhesion between bond coat 14 and overlying layer 16, reduce diffusion of elements through bond coat 14, or both.

Bond coat 14 additionally or alternatively may include at least one of a transition metal carbide, a transition metal boride, or a transition metal nitride. Bond coat 14 may include silicon and at least one transition metal carbide; silicon and at least one transition metal boride; silicon and at least one transition metal nitride; silicon, at least one transition metal carbide, and at least one transition metal boride; silicon, at least one transition metal carbide, and at least one transition metal nitride; silicon, at least one transition metal boride, and at least one transition metal nitride; or silicon, at least one transition metal carbide, at least one transition metal boride, and at least one transition metal nitride. The transition metal may include, for example, Cr, Mo, Nb, W, Ti, Ta, Hf, or Zr. The at least one transition metal carbide may include at least one of Cr₃C₂, Cr₇C₃, Cr₂₃C₆, Mo₂C, NbC, WC, TaC, HfC, or ZrC. The at least one transition metal boride may include at least one of TaB, TaB₂, TiB₂, ZrB₂, HfB, or HfB₂. The at least one transition metal nitride may include at least one of TiN, ZrN, HfN, Mo₂N, or TaN.

Transition metal carbides, transition metal borides, and transition metal nitrides may have a different CTE than silicon. For example, transition metal carbides and transition metal borides may have CTEs between about 5 ppm/° C. and about 8 ppm/° C., and transition metal nitrides may have CTEs of about 9 ppm/° C. By mixing silicon and a transition metal carbide, a transition metal boride, or both, the CTE of bond coat 14 may be increased to more closely match the CTE of substrate 12, the CTE of overlying layer 16, or both. This may reduce stress at the interfaces between substrate 12 and bond coat 14, between bond coat 14 and overlying layer 16, or both, during thermal cycling of article 10.

Additionally, or alternatively, the addition of the at least one of the transition metal carbide, the transition metal boride, or the transition metal nitride may improve oxidation resistant of bond coat 14 compared to a bond layer including only silicon. For example, the at least one of the transition metal carbide, the transition metal boride, or the transition metal nitride may be incorporated into the thermally grown silicon oxide, which may improve adherence of the thermally grown silicon oxide to the bond layer, decrease oxygen diffusivity through the thermally grown silicon oxide (which reduces the rate of oxidation of the remaining bond layer), or both.

In some examples, bond coat 14 may include silicates of rare earth elements (i.e., a rare earth silicate) including Lu (lutetium), Yb (ytterbium), Tm (thulium), Er (erbium), Ho (holmium), Dy (dysprosium), Tb (terbium), Gd (gadolinium), Eu (europium), Sm (samarium), Pm (promethium), Nd (neodymium), Pr (praseodymium), Ce (cerium) La (lanthanum), Y (yttrium), or Sc (scandium).

Bond coat 14 may define any suitable thickness, measured in a direction substantially normal to a surface of substrate 12. In some examples, bond coat 14 defines a thickness of between about 0.5 mils (about 12.7 micrometers) and about 40 mils (about 1016 micrometers), such as between about 0.5 mils (about 12.7 micrometers) and about 10 mils (about 254 micrometers).

Bond coats discussed herein, such as bond coat 14 of FIG. 1, may be formed through introduction of a reactive gas into pores of a porous silicon coat. FIG. 2A is a cross-sectional diagram of an example of an article 30 that includes a substrate 32 coated with a porous silicon coat 34 prior to introduction of a reactive gas. Porous silicon coat 34 is a precursor coating to bond coat 14 of FIG. 1. Substrate 32 may be similar to substrate 12 of FIG. 1.

Porous silicon coat 34 includes an outer surface 42 and an inner surface 44 on substrate 32. Porous silicon coat 34 may include a bulk phase 36 of silicon or silicon-containing alloy with a plurality of pores 38 extending through bulk phase 36. For example, deposition of porous silicon coat 34 on substrate 32 may result in formation of a plurality of pores 38 within porous silicon coat 34. In some examples, after applying bond coat 14 to substrate 12, bond coat 14 may include between about 1 vol. % and about 15 vol. % of pores 38, or between about 3 vol. % and about 8 vol. % of pores 38. The volume percentage of the porosity of bond coat 14 may be determined using a variety of analytic methods including, for example, microscopy and image analysis.

In some examples, the plurality of pores 38 may include continuous porosity networks (e.g., open porosity) and discontinuous pores (e.g., closed porosity). For example, at least a portion of plurality of pores 38 may form porosity networks that extend substantially from surface 42 to surface 44 (e.g., continuous pores that may allow ingress of oxygen or water vapor into substrate 32).

In some examples, a portion of the plurality of pores 38 may include pores of splat boundaries. For example, porous silicon coat 34 may be formed by plasma spraying. During plasma spraying, molten silicon may contact substrate 32 or silicon on porous silicon coat 34, deform from the contact, and solidify to form two-dimensional splats. As a result, splat boundaries between these splats may form in porous silicon coat 34. These splat boundaries may extend through porous silicon coat 34, creating a network of narrow through-ways for oxygen or water vapor into substrate 32.

The plurality of pores 38 may allow infiltration of elements or compounds (e.g., oxygen or water vapor) through porous silicon coat 34, potentially resulting in contact of the elements or compounds with at least a portion of substrate 32. Contact of the elements or compounds (e.g., oxygen or water vapor) with at least a portion of substrate 32 may result in oxidation of at least a portion of substrate 32. Oxidation of at least a portion of substrate 32 may lead to premature failure of at least a portion of article 30 or otherwise damage substrate 32. For example, during operation of article 30, water vapor and/or oxygen in the operating environment of article 30 may infiltrate through a barrier layer (not shown) into porous silicon coat 34, and through pores 38. The infiltrated water vapor and/or oxygen may contact substrate 32 which may result in oxidation, as described above.

To reduce a porosity of porous silicon coat 34, silicon adjacent the plurality of pores 38 of porous silicon coat 34 may be reacted with a reactive gas to form a bond coat 52. FIG. 2B is a cross-sectional diagram of an example of an article 50 that includes substrate 32 coated with bond coat 52 after introduction of a reactive gas. Substrate 32 and bond coat 52 may be similar to substrate 12 and bond coat 14 of FIG. 1.

After introducing a reactive gas into pores of the porous silicon coat 34, the reactive gas reacts with silicon adjacent the plurality of pores 38 of porous silicon coat 34 to form a ceramic phase 56 of bond coat 52 comprising a silicon-based ceramic. The reactive gas may be introduced into substantially all open pores of the plurality of pores 38 within porous silicon coat 34. The reactive gas may include at least one element or compound that may infiltrate at least some of the plurality of pores 38 and react with silicon 40 adjacent pores 38 of porous silicon coat 34 to form a ceramic phase of bond coat, such as ceramic phase 56 of bond coat 52 in FIG. 2B. Formation of ceramic phase 56 may allow at least some of the plurality of pores 38 to be substantially filled and thereby reduce the open porosity of bond coat 52. For example, the reaction of the reactive gas with silicon 40 adjacent to the plurality of pores 38 may form the silicon-based ceramic of ceramic phase 56. This silicon-based ceramic may have a higher molar volume per mole of silicon than the molar volume of silicon 40 adjacent the plurality of pores 38. As such, the volume expansion of the silicon-based ceramic reduces a volume of the plurality of pores 38 and closes continuous porosity of bond coat 52. For example, a reaction between silicon (Si) and ammonia (NH₃) to form silicon nitride (Si₃N₄) may be expressed below:

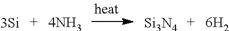

The reactive gas may include any gas that is capable of reacting with silicon in porous silicon coat 34 to form the silicon-based ceramic. In some examples, the reactive gas includes a nitrogen-containing gas, such as at least one of ammonia gas or nitrogen gas. For example, ammonia gas may infiltrate at least some of the plurality of pores 38 and react with silicon adjacent pores 38 to form silicon nitride. Silicon nitride has a greater volume than an equivalent amount of reacted silicon, such that a volume of pores 38 is reduced. In some examples, the reactive gas may include a carbon-containing gas such as methane that may decompose to carbon and react with silicon in porous silicon coat 34. For example, methane may infiltrate at least some of the plurality of pores 38 and decompose to carbon, which may then react with silica adjacent pores 38 to form silicon carbide.

After reacting the reactive gas with silicon adjacent the plurality of pores 38, the plurality of pores 38 may be at least partially filled with a silicon-based ceramic to form bond coat 52 having bulk phase 54 of silicon and ceramic phase 56 of silicon-based ceramic. In some examples, silicon-based ceramic may not completely fill a volume of a pore, such that non-continuous pores 58 may be formed within the silicon-based ceramic of ceramic phase 56.

Bond coat 52 of FIG. 2B may be substantially the same as porous silicon coat 34, except that the plurality of pores 38 and silicon 40 adjacent pores 38 of porous silicon coat 34 may be substantially filled with the silicon-based ceramic such that bond coat 52 may be substantially free of continuous porosity extending through the thickness of bond coat 52. For example, a porosity of bond coat 52 may be less than about 10 vol. %, less than about 5 vol. %, or less than about 1 vol. %, where porosity is measured as a percentage of pore volume divided by total volume of bond coat 52, and/or bond coat 52 may be substantially free of continuous porosity extending from surface a top surface of bond coat 52 to a bottom surface of bond coat 52.

In examples in which the plurality of pores 38 are substantially filled with silicon-based ceramic, the infiltration of elements or compounds present in the operating environment of article 50 (e.g., oxygen or water vapor) through bond coat 52 may be reduced or substantially slowed. Reducing or substantially slowing the infiltration of elements or compounds through bond coat 52 may reduce or slow contact of the elements or compounds with substrate 32. Reducing or substantially slowing the contact of the elements or compounds with substrate 32 may reduce or substantially slow oxidation of substrate 32. Reducing or substantially slowing oxidation of substrate 32 may reduce or substantially slow damage to substrate 32 or the substrate 32 and barrier coating (not shown) system.

By incorporating ceramic phase 56 into bond coat 52 to replace at least some volume of pores, bond coat 52 may have improved properties over porous silicon coat 34, or other porous silicon bond coats. Bond coat 52 may have increased density for improved environmental resistance. In some examples, a density of bond coat 52 is greater than a density of porous silicon coat 34. For example, ceramic phase 56 may replace pores 38 and silicon 40 adjacent pores 38, such that a volume of pores is lower, and a corresponding density higher, in bond coat 52. Bond coat 52 may have a lower continuous porosity than porous silicon coat 34. In some examples, a volume ratio of continuous porosity of porous silicon coat 34 to continuous porosity of bond coat 52 is greater than about 10. Put another way, a volume of continuous pores extending through porous silicon coat 34 may be at least about 10 times as high as a volume of continuous pores through bond coat 52. In this way, bond coat 52 may operate as a diffusion barrier for reactive species penetrating through, for example, a barrier coating on bond coat 52. Bond coat 52 may also have improved mechanical properties over porous silicon coat 34, such as a higher creep resistance than porous silicon coat 34 or a higher fracture toughness than porous silicon coat 34. Bond coat 52 may have a higher temperature capability than porous silicon coat 34, as bond coat 52 incorporates a silicon-based ceramic that may have a higher melting temperature than silicon.

In some examples, increasing the density of bond coats discussed herein, such as bond coat 14 of FIG. 1 and bond coat 52 of FIG. 2B, may reduce the porosity of bond coat 14 and thereby reduce the permeability of bond coat 14 to elements and compounds (e.g., oxygen or water vapor) present in the operating environment of an article, such as article 10 or article 50, that may oxidize an underlying substrate, such as substrate 12 or substrate 32, or otherwise damage a respective article. For example, materials of a high temperature mechanical system, such as silicon-containing materials, may be vulnerable to chemical attack by elements and compounds (e.g., oxygen or water vapor) present in the operating environment of high temperature mechanical systems or during servicing of high temperature mechanical system. The high temperature mechanical system may include components of an aircraft engine such as turbine blades, vanes, and the like.

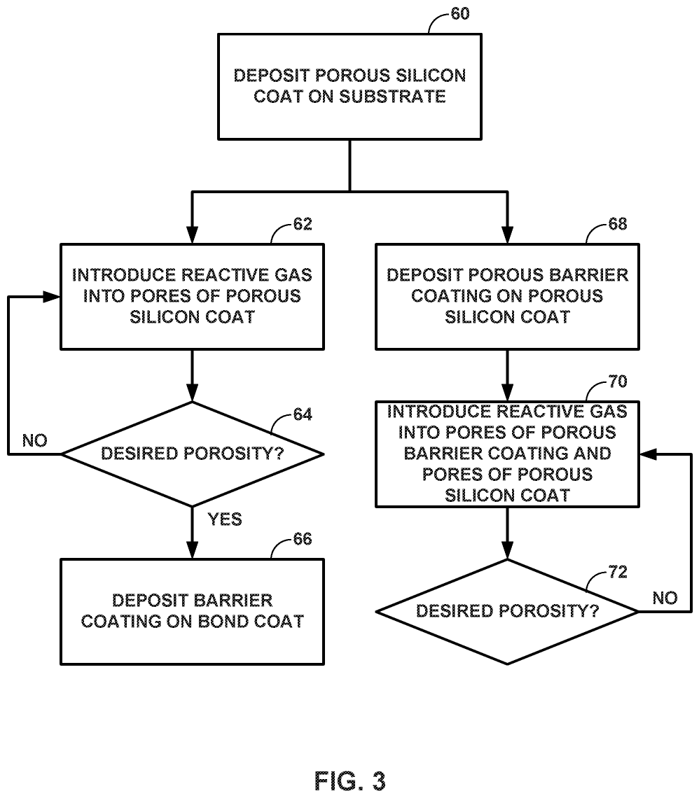

FIG. 3 is a flowchart of an example process for manufacturing an article that includes a substrate coated with a bond coat and a barrier coating. The technique of FIG. 3 will be described with respect to articles 30 and 50 of FIGS. 2A and 2B, respectively, for ease of description only. A person having ordinary skill in the art will recognize and appreciate that the technique of FIG. 3 may be used to form articles other than articles 30 and 50 of FIGS. 2A and 2B, such as article 10 of FIG. 1.

The technique of FIG. 3 may include depositing porous silicon coat 34 on substrate 32 to form bulk phase 36 of a bond coat, such as bond coat 52 of FIG. 2B. Porous silicon coat 34 may be deposited using any technique that leaves residual porosity in porous silicon coat 34. In some examples, porous silicon coat 34 may be deposited using at least one of air plasma spray, high velocity oxygen fuel (HVOF) coating, low vapor plasma spray, solution plasma spray, plasma spray-physical vapor deposition (PS-PVD), electrophoretic deposition, or slurry deposition. For example, porous silicon coat 34 may be deposited using a slurry comprising silicon metal and at least one of mullite or silicon-aluminum-oxygen-nitrogen (SiAlON) ceramic particles, such that the mullite or SiAlON ceramic particles constitute a second ceramic phase, in addition to a ceramic phase 20 having the silicon-based ceramic. Depositing porous silicon coat 34 on substrate 32 may result in formation of a plurality of pores 38 within porous silicon coat 34. In some examples, the plurality of pores 38 may include continuous porosity networks (e.g., open porosity) and discontinuous pores (e.g., closed porosity). In some examples, at least a portion of plurality of pores 38 may form porosity networks that extend substantially from surface 42 to surface 44 (e.g., continuous pores that may allow ingress of oxygen or water vapor into substrate 12). In some examples, after applying porous silicon coat 34 to substrate 32, porous silicon coat 34 may include between about 1 vol. % and about 15 vol. % of pores 38, or between about 3 vol. % and about 8 vol. % of pores 38. In some examples, porous silicon coat 34 comprises at least one of silicon metal or a silicon alloy.

In some examples, it may be desired to reduce a porosity of porous silicon coat 34 before depositing a barrier coating. For example, the barrier coating may not have sufficient porosity to pass through a reactive gas, such that an insufficient amount of reactive gas reacts with silicon adjacent pores 38 and/or a rate of reaction of the reactive gas with silicon in pores 38 is too low.

In some examples, the example of FIG. 3 includes introducing a reactive gas into pores of porous silicon coat 34 (62). The reactive gas may be introduced into at least some pores of the plurality of pores 38. For example, the reactive gas may infiltrate into substantially all pores of the plurality of pores 38 that are open to surface 42 or are connected to surface 42 by a porous network. In other words, in some examples, the reactive gas may be introduced into substantially all open pores within porous silicon coat 34. In some examples, the reactive gas has a pressure between about 1 torr and about 765 torr. In some examples, the reactive gas may be heated prior to introduction into porous silicon coat 34.

In some examples, the technique of FIG. 3 may include, after introducing the reactive gas, heat-treating porous silicon coat 34 and the reactive gas. In some examples, heat-treating porous silicon coat 34 and the reactive gas may include heat-treating porous silicon coat 34 and the reactive gas at a temperature greater than about 1000° C. In some examples, the temperature of the reactive gas is greater than about 1100° C. and less than about 1450° C. (e.g., about a melting point of silicon at 1412° C.). Heat-treating may include heating bond coat 14 and the precursor by any suitable means. For example, heating may include heating by conduction, convection, or radiation using a furnace, a laser, a plasma, an arc welding apparatus, or the like. A temperature of the reactive gas may be dependent on a variety of factors such as reaction rate, composition of porous silicon coat 34, composition of the reactive gas, and the like.

The reactive gas reacts with silicon 40 adjacent the pores 38 of porous silicon coat 34 to form ceramic phase 56 of bond coat 52 comprising a silicon-based ceramic. The reactive gas may be introduced into pores of porous silicon coat 34 and/or porous silicon coat 34 and the reactive gas may be heat treated for a sufficient time for the reactive gas to react with silicon adjacent the pores of porous silicon 34 and reduce the porosity of the resulting bond coat 52. In some examples, the reactive gas may be introduced and/or porous silicon coat 34 and the reactive gas heat treated for a duration between about 10 minutes and about 10 hours, such that the reactive gas may react with silicon 40 adjacent the pores of porous silicon coat 34.

The reactive gas may include at least one element or compound that may infiltrate at least some of the plurality of pores 38 and react with silicon adjacent pores 38 of porous silicon coat 34 to form a ceramic phase of a bond coat, such as ceramic phase 56 of bond coat 52 in FIG. 2B. Formation of ceramic phase 56 may allow at least some of the plurality of pores 38 to be substantially filled and thereby reduce the open porosity of bond coat 52. In some examples, the reactive gas may include any gas capable of reacting with silicon and reducing a volume of pores 38.

In some examples, the reactive gas comprises at least one of ammonia gas or nitrogen gas. For example, ammonia gas may infiltrate at least some of the plurality of pores 38 and react with silicon adjacent pores 38 to form silicon nitride. Silicon nitride has a greater volume than an equivalent amount of reacted silicon, such that a volume of pores 38 is reduced. As an example, ammonia may be introduced into pores of porous silicon coat 34 that includes silicon. The ammonia may react with silicon 40 adjacent pores 38 of porous silicon coat 34 to form silicon nitride. The silicon nitride product, having a greater molar volume than the silicon reactant, may expand to fill at least a portion of the pore volume. As a result, bond coat 52 includes ceramic phase 56 of silicon nitride dispersed in bulk phase 54 of silicon.

After reacting the reactive gas with silicon 40 adjacent the plurality of pores 38, the plurality of pores 38 may be at least partially filled with a silicon-based ceramic. In some examples, the reactive gas may react with one or more constituents of substrate 32 to form a reaction product (e.g., silicon in substrate 32 may react with nitrogen in the reactive gas to form silicon nitride).

The technique of FIG. 3 also may include, after introducing reactive gas into pores 38 of porous silicon coat 34, determining if resulting bond coat 52 has a desired porosity (64). If the porosity is determined to be sufficient (YES branch of decision block 64), the technique may not include further introduction of the reactive gas into pores of porous silicon coat 34. Porosity of bond coat 52 may be determined by, for example, measuring a change in weight of the substrate 12 and bond coat 52 before and after introduction of the reactive gas, and using a known density of the silicon-based ceramic to estimate a volume occupied by the silicon-based ceramic. As another example, porosity of bond coat 52 may be determined by image analysis of a cross-section of bond coat 52 after introduction of the reactive gas. In some examples, if porosity of bond coat 52 is less than about 10 vol. %, less than about 5 vol. %, or less than about 1 vol. %, where porosity is measured as a percentage of pore volume divided by total volume of bond coat 52, and/or bond coat 52 is substantially free of continuous porosity extending through the thickness of bond coat 52, then the porosity of bond coat 52 may be considered sufficient.

If the porosity is determined to be too high (NO branch of decision block 64), then the technique may include repeating the step of introducing the reactive gas (62). For example, if porosity of bond coat 52 is greater than about 10 vol. %, greater than about 5 vol. %, or greater than about 1 vol. %, and/or if bond coat 52 is not substantially free of continuous porosity extending through the thickness of bond coat 52, then the porosity of bond coat 52 may be considered too high, and introduction of the reactive gas (62) may be repeated or continued.

The example of FIG. 3 includes, after determining that the porosity of bond coat 52 is sufficient (YES branch of decision block 64), depositing a barrier coating, such as barrier coating 16 of FIG. 1, on bond coat 52 (66). As described above, barrier layer 16 may include, for example, at least one of an EBC, an abradable layer, a TBC, a CMAS-resistant layer, or the like. For example, the technique of FIG. 3 may include, after determining that the porosity of bond coat 52 is sufficient (YES branch of decision block 38), applying an EBC on bond coat 52 and applying an abradable layer on the EBC.

In some examples, it may be desired to deposit a barrier coating before reducing a porosity of porous silicon coat 34. For example, the barrier coating or other overlying coating, such as an abradable coating, may have sufficient porosity to pass through a reactive gas, such that a sufficient amount of reactive gas reacts with silicon in pores 38 and/or a rate of reaction of the reactive gas with silicon in pores 38 is high.

In some examples, the example of FIG. 3 includes depositing a porous barrier coating, such as barrier coating 16 of FIG. 1, on porous silicon coat 34 or bond coat 52 (68) prior to introducing the reactive gas. As described above, barrier layer 16 may include, for example, at least one of an EBC, an abradable layer, a TBC, a CMAS-resistant layer, or the like.

In some examples, the example of FIG. 3 includes introducing the reactive gas into pores of the porous barrier coating and the pores of porous silicon coat 34 (70). The reactive gas reacts with silicon adjacent the pores of porous silicon coat 34 to form the ceramic phase of the bond coat comprising a silicon-based ceramic. The reactive gas may be introduced into at least some pores of the plurality of pores 38. For example, the reactive gas may be introduced into substantially all pores of the plurality of pores 38 that are open to surface 42 or are connected to surface 42 by a porous network. In other words, in some examples, the reactive gas may be introduced into substantially all open pores within porous silicon coat 34.

The technique of FIG. 3 also may include, after introducing reactive gas into pores 38 of porous silicon coat 34, determining if resulting bond coat 52 has a desired porosity (72). If the porosity is determined to be sufficient (YES branch of decision block 72), the technique may not include further introduction of the reactive gas into pores of porous silicon coat 34, as explained with respect to step 64 above. If the porosity is determined to be too high (NO branch of decision block 72), then the technique may include repeating the step of introducing the reactive gas (62). For example, if porosity of bond coat 52 is greater than about 10 vol. %, greater than about 5 vol. %, or greater than about 1 vol. %, and/or if bond coat 52 is not substantially free of continuous porosity extending through the thickness of bond coat 52, then the porosity of bond coat 52 may be considered too high, and introduction of the reactive gas (70) may be repeated or continued.

Various examples have been described. These and other examples are within the scope of the following claims.

What is claimed is:

1. A method comprising:
depositing a porous silicon coat on a substrate to form a bulk phase of a bond coat; and
introducing a reactive gas into pores of the porous silicon coat,
wherein the reactive gas reacts with silicon adjacent the pores of the porous silicon coat to form a ceramic phase of the bond coat comprising a silicon-based ceramic and reduce a porosity of the porous silicon coat, and
wherein a temperature of the reactive gas is greater than about 1000° C.

2. The method of claim 1, wherein the temperature of the reactive gas is greater than about 1100° C. and less than about 1450° C.

3. The method of claim 1, further comprising heat treating the reactive gas and the porous silicon coat.

4. The method of claim 1, wherein the reactive gas comprises at least one of ammonia gas or nitrogen gas.

5. The method of claim 1, further comprising depositing a barrier coating on the bond coat.

6. The method of claim 1, further comprising depositing a barrier coating on the porous silicon coat prior to introducing the reactive gas, wherein the barrier coating is porous.

7. The method of claim 1, wherein the porous silicon coat is deposited using at least one of air plasma spray, high velocity oxygen fuel (HVOF) coating, low vapor plasma spray, solution plasma spray, plasma spray-physical vapor deposition (PS-PVD), or electrophoretic deposition.

8. The method of claim 1, wherein the ceramic phase is a first ceramic phase, and wherein the porous silicon coat is deposited using a slurry comprising silicon metal and at least one of mullite or silicon-aluminum-oxygen-nitrogen (SiAlON) ceramic particles that form a second ceramic phase, different from the first ceramic phase.

9. The method of claim 1, wherein the porous silicon coat comprises at least one of silicon metal or a silicon alloy.

10. The method of claim 1, wherein the bond coat comprises greater than about 0.5 vol. % and less than about 15 vol. % of the ceramic phase.

11. The method of claim 1, wherein a density of the bond coat is greater than a density of the porous silicon coat.

12. The method of claim 1, wherein a volume ratio of continuous porosity of the porous silicon coat to continuous porosity of the bond coat is greater than about 10.

13. The method of claim 1, wherein the silicon-based ceramic comprises silicon nitride (Si₃N₄).

14. An article comprising:
a substrate;
a bond coat on the substrate; and
a barrier coating on the bond coat,
wherein the bond coat comprises a bulk phase comprising silicon and a ceramic phase comprising a silicon-based ceramic, and
wherein the bond coat comprises greater than about 0.5 vol. % and less than about 15 vol. % of the ceramic phase.

15. The article of claim 14, wherein the silicon-based ceramic comprises silicon nitride (Si₃N₄).

16. The article of claim 15, wherein the ceramic phase further comprises silicon carbide (SiC).

17. The article of claim 14, wherein the bond coat comprises a thickness between about 12.7 micrometers and about 1016 micrometers.

18. The article of claim 14, wherein the bond coat has a higher concentration of the silicon-based ceramic adjacent to the barrier coating than adjacent to the substrate.

19. The article of claim 14, wherein a molar volume of the silicon-based ceramic is greater than a molar volume of silicon.

20. The article of claim 14, wherein the substrate is a ceramic matrix composite (CMC), and wherein the barrier coating is an environmental barrier coating (EBC).
